(19) United States
(12) Patent Application Publication
(10) Pub. No.: US 2025/0291286 A1
(43) Pub. Date: Sep. 18, 2025

(54) IMAGE FORMING APPARATUS

(71) Applicant: CANON KABUSHIKI KAISHA, Tokyo (JP)

(72) Inventors: SEIJI OBATA, Shizuoka (JP); TOMOOKU KOYAMA, Shizuoka (JP); HIDEKI OHTA, Shizuoka (JP); JIRO MORIYA, Shizuoka (JP)

(21) Appl. No.: 19/072,158

(22) Filed: Mar. 6, 2025

(30) Foreign Application Priority Data
Mar. 13, 2024 (JP) 2024-039389

(51) Int. Cl. G03G 15/20; G03G 21/16

(52) U.S. Cl. CPC G03G 15/2035; G03G 15/2064; G03G 21/1633; G03G 21/1647; G03G 2221/1639; G03G 2221/1654

(57) ABSTRACT

An image forming apparatus includes an apparatus body provided with an opening portion, an opening/closing member supported to be openable and closable with respect to the apparatus body between a closed position and an open position, a fixing unit, and a moving unit provided in the apparatus body and configured to move the fixing unit from a first position toward a second position. A movement of the fixing unit from the first position to the second position is restricted in a state in which the opening/closing member is positioned at the closed position and is allowed in a state in which the opening/closing member is positioned at the open position. The moving unit includes a support portion configured to support the fixing unit positioned at the second position, and a restricting portion configured to restrict dropping of the fixing unit supported by the support portion from the support portion.

### BACKGROUND OF THE INVENTION

### Field of the Invention

The present invention relates to an image forming apparatus that forms a toner image on a sheet.

### Description of the Related Art

In Japanese Patent Application Laid-Open No. 2012-047806, an image forming apparatus including a pair of arm members provided to be pivotable with respect to an apparatus body, and a fixing unit held at a distal end portion of the arm members is proposed. The fixing unit is configured to be movable between an internal attached position and a temporary holding position closer to an opening portion of the apparatus body than the internal attached position by pivoting the pair of arm members.

However, there is a possibility that the fixing unit described in Japanese Patent Application Laid-Open No. 2012-047806 drops from the pair of arm members when a strong external force is applied to the fixing unit. For example, when removing a sheet jammed in the state of being nipped in the fixing unit, there is a possibility that the fixing unit drops from the arm members as a result of the user pulling the sheet.

### SUMMARY OF THE INVENTION

According to one aspect of the present invention, an image forming apparatus configured to form a toner image on a sheet includes an apparatus body provided with an opening portion, an opening/closing member supported to be openable and closable with respect to the apparatus body between a closed position where the opening/closing member covers the opening portion and an open position where the opening/closing member opens the opening portion, a fixing unit supported to be attachable to and detachable from the apparatus body via the opening portion and configured to fix the toner image to the sheet by applying heat and pressure to the sheet, and a moving unit provided in the apparatus body and configured to move the fixing unit from a first position toward a second position different from the first position. A movement of the fixing unit from the first position to the second position is restricted in a state in which the opening/closing member is positioned at the closed position and is allowed in a state in which the opening/closing member is positioned at the open position. The moving unit includes a support portion configured to support the fixing unit positioned at the second position, and a restricting portion configured to restrict dropping of the fixing unit supported by the support portion from the support portion.

Further features of the present invention will become apparent from the following description of exemplary embodiments with reference to the attached drawings.

### BRIEF DESCRIPTION OF THE DRAWINGS

FIG. 1 is a section view of an image forming apparatus.

FIG. 2 is a perspective view illustrating a state in which a fixing unit has been detached from a moving unit.

FIG. 3 is a section view of the image forming apparatus in a state in which a door is open.

FIG. 4 is a section view of the image forming apparatus in a state in which the fixing unit has been lifted up to a second position.

FIG. 5 is a section view of the image forming apparatus in a state in which a transfer unit and a tray unit have been drawn out through an opening portion.

FIG. 6A is a perspective view of the image forming apparatus in a state in which the door is open.

FIG. 6B is a perspective view of the fixing unit positioned at the second position.

FIG. 7A is an enlarged perspective view of a restricting member and a locking member on the left side.

FIG. 7B is an enlarged perspective view of a restricting member, a locking member, and a cancellation lever on the right side.

FIG. 8 is a perspective view illustrating a state in which the locking member has moved to a detachment allowing position.

FIG. 9 is a section view illustrating a state in which a pressing rib of the door presses the locking member.

FIG. 10 is a section view illustrating a state in which a top surface of the door presses the restricting member.

FIG. 11 is a perspective view illustrating how jam removal of a sheet nipped in the fixing unit is performed.

### DESCRIPTION OF THE EMBODIMENTS

### Overall Configuration

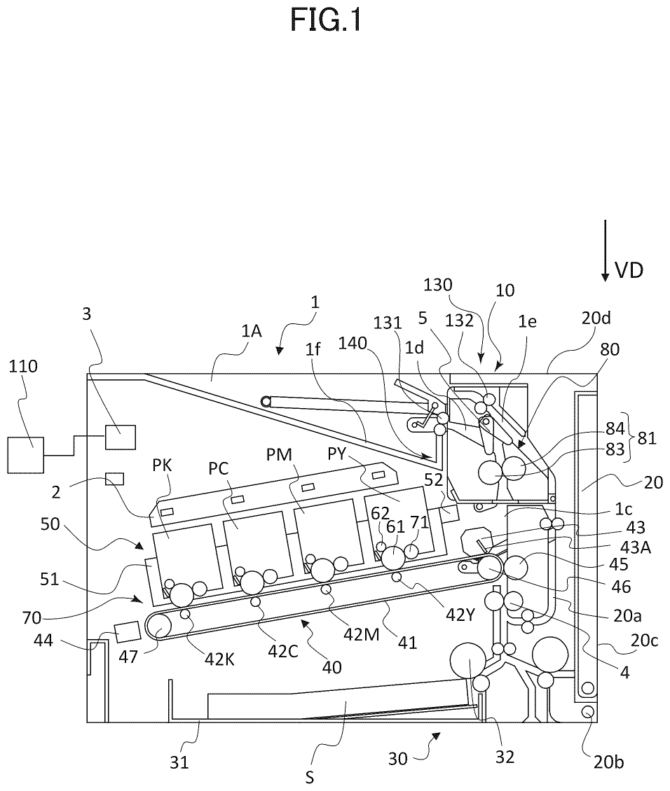

An image forming apparatus 1 according to the present embodiment is a full-color laser beam printer of an electrophotographic system. FIG. 1 is a section view of the image forming apparatus 1.

To be noted, examples of the image forming apparatus include printers, copiers, facsimile machines, and multifunctional apparatuses, which are apparatuses that form an image on a sheet used as a recording medium on the basis of image information input from an external personal computer (PC), image information read from a document, or the like. In addition, there is a case where a peripheral device such as an optional feeder, an image reading apparatus, or a sheet processing apparatus is coupled to a body having an image forming function, and the entire system in which the peripheral device is coupled to the body also serves as an image forming apparatus. In addition, examples of the sheet include paper such as paper sheets and envelopes, plastic films such as sheets for overhead projectors, and cloths.

As illustrated in FIG. 1, the image forming apparatus 1 includes an apparatus body 1A provided with an opening portion 9, and a door 20 serving as an opening/closing member supported to be openable and closable between a closed position where the door 20 covers the opening portion 9 and an open position where the door 20 opens the opening portion 9 with respect to the apparatus body 1A. The door 20 is configured to be pivotable about a pivot shaft 20b. To be noted, the frame and exterior of the apparatus body 1A and the door 20 can be also collectively referred to as a main frame 10.

The apparatus body 1A accommodates an image forming unit 70 that forms an image on a sheet S, a feeding unit 30, a fixing unit 80, a discharge unit 130, and a moving unit 140 that will be described later. The image forming unit 70 includes a transfer unit 40, a tray unit 50 disposed above the transfer unit 40, and a scanner 2 disposed above the tray unit 50.

The tray unit 50 includes a tray 51 that can be drawn out from the apparatus body 1A, and four process cartridges PY, PM, PC, and PK that respectively form toner images of four colors of yellow (Y), magenta (M), cyan (C), and black (K). The four process cartridges PY, PM, PC, and PK are placed on the tray 51. The tray 51 includes a tray handle 52 that the user can grip.

To be noted, the four process cartridges PY, PM, PC, and PK have the same configuration except for the color of the image formed thereby. Therefore, only the configuration and image forming process of the process cartridge PYwill be described, and description of the process cartridges PM, PC, and PK will be omitted.

The process cartridge PY includes a photosensitive drum 61, a charging roller 62, and a developing roller 71. The photosensitive drum 61 is formed by applying an organic photoconductive layer on the outer peripheral surface of an aluminum cylinder, and is rotated by an unillustrated driving motor. The directions of the rotational axes of the photosensitive drum 61, the developing roller 71, and the charging roller 62 are parallel to each other.

The transfer unit 40 includes a driving roller 46, a tension roller 47, and an intermediate transfer belt 41 looped over the driving roller 46 and the tension roller 47. Primary transfer rollers 42Y, 42M, 42C, and 42K are provided on the inner peripheral side of the intermediate transfer belt 41. In addition, a secondary transfer roller 45 is provided to oppose the driving roller 46 with the intermediate transfer belt 41 therebetween, and the intermediate transfer belt 41 and the secondary transfer roller 45 form a transfer nip where an image is transferred onto the sheet S conveyed thereto. To be noted, an optical sensor 44 that detects a toner image transferred onto the intermediate transfer belt 41 is disposed in the image forming unit 70. The directions of the rotational axes of the primary transfer rollers 42Y, 42M, 42C, and 42K, the driving roller 46, the tension roller 47, and the secondary transfer roller 45 are parallel to each other.

The feeding unit 30 is provided in a lower portion of the image forming apparatus 1, and includes a cassette 31 that supports the sheet S, and a pickup roller 32 that feeds the sheet S supported by the cassette 31. The cassette 31 is configured to be attachable to and detachable from the apparatus body 1A on the same side as the opening portion 9. The discharge unit 130 includes a discharge roller pair 131 and a discharge tray if that supports the sheet S discharged by the discharge roller pair 131.

The fixing unit 80 includes a fixing portion 81 that fixes the toner image on the sheet to the sheet by applying heat and pressure to the sheet, a guiding member 5, and a reverse conveyance roller pair 132. The fixing portion 81 includes a heating roller 83 serving as a heating unit including an unillustrated heater, and a pressurizing roller 84, and the heating roller 83 and the pressurizing roller 84 form a fixing nip that nips the sheet S. The guiding member 5 is configured to be pivotable to a discharge position and a reverse conveyance position. The guiding member 5 guides the sheet S toward a discharge path 1d at the discharge position, and toward a reverse conveyance path 1e at the reverse conveyance position.

Next, an image forming operation of the image forming apparatus 1 configured in this manner will be described. The image forming apparatus 1 includes a controller 3 connected to an external host apparatus 110. The controller 3 controls, on the basis of an image signal received from the external host apparatus 110 or the reading unit, a scanner 2 to radiate laser light corresponding to the image signal onto the photosensitive drum 61 of the process cartridge PY Examples of the external host apparatus 110 include personal computers, image readers, and facsimile machines.

At this time, the surface of the photosensitive drum 61 is uniformly charged to a predetermined polarity and potential by the charging roller 62, and an electrostatic latent image is formed thereon by the irradiation of the surface with the laser light from the scanner 2. The electrostatic latent image formed on the photosensitive drum 61 is developed by the developing roller 71, and a yellow (Y) toner image is formed on the photosensitive drum 61.

To be noted, the developing roller 71 is configured to be capable of coming into contact with and out of contact from the photosensitive drum 61. The lifetime of the photosensitive drum 61 and the developing roller 71 can be elongated by separating the developing roller 71 from the photosensitive drum 61 when the image forming apparatus 1 does not perform the image forming operation.

Similarly, the respective photosensitive drums of the process cartridges PM, PC, and PK are irradiated with laser light from the scanner 2, and thus magenta (M), cyan (C), and black (K) toner images are formed on the respective photosensitive drums. The toner images of the respective colors formed on the respective photosensitive drums are transferred onto the intermediate transfer belt 41 by the primary transfer rollers 42Y, 42M, 42C, and 42K, and are conveyed to a transfer nip by the intermediate transfer belt 41 rotated by the driving roller 46. To be noted, the image forming process of each color is performed at such a timing that each toner image formed by a process cartridge positioned more downstream is superimposed on a toner image that has been formed by a process cartridge positioned more upstream and that has been already transferred onto the intermediate transfer belt 41 through primary transfer. In addition, the residual toner remaining on the photosensitive drum 61 is removed by a cleaning blade.

In parallel with this image forming process, the sheet S accommodated in the cassette 31 of the feeding unit 30 is fed out to a conveyance path 1c by the pickup roller 32. Then, the skew of the sheet S is corrected by the registration roller pair 4 provided in the conveyance path 1c, and the sheet S is conveyed at a predetermined conveyance timing matching the transfer timing of the image at the transfer nip.

Then, the full-color toner image on the intermediate transfer belt 41 is transferred onto the sheet S at the transfer nip by a secondary transfer bias applied to the secondary transfer roller 45. In addition, the residual toner remaining on the intermediate transfer belt 41 is removed by a cleaning blade 43A provided in the cleaning portion 43. The sheet S onto which the toner image has been transferred is subjected to a predetermined heat and pressure applied by the heating roller 83 and the pressurizing roller 84 of the fixing unit 80, and thus toner is melted and adheres (is fixed) thereto. The sheet S having passed through the fixing unit 80 is guided to the discharge path 1d or the reverse conveyance path 1e by the guiding member 5.

When a simplex printing job for printing an image on only one surface is input, the guiding member 5 is positioned at a discharge position, and the sheet S is guided to the discharge path 1d. The sheet S guided to the discharge path 1d is discharged to the outside of the apparatus by the discharge roller pair 131, and is supported by the discharge tray 1f.

When a duplex printing job for forming an image on each surface of the sheet S is input, the sheet S on a first surface of which an image has been formed at the transfer nip is guided to the reverse conveyance path 1e by the guiding member 5 positioned at the reverse conveyance position. The reverse conveyance roller pair 132 provided in the reverse conveyance path 1e rotates in a reverse direction after the trailing end of the sheet S has passed the guiding member 5, and thus switches back the sheet S. In the meantime, the guiding member 5 moves to the discharge position, and the sheet S that has been switched back is guided to a duplex conveyance path 20a by the guiding member 5.

The sheet S guided to the duplex conveyance path 20a is conveyed to the conveyance path 1c by a plurality of conveyance roller pairs, and thus an image is formed on a second surface thereof at the transfer nip. Then, the toner image is fixed to the sheet S by the fixing unit 80 as described above, and then the sheet S is discharged onto the discharge tray if by the discharge roller pair 131.

### Schematic Configuration of Moving Unit

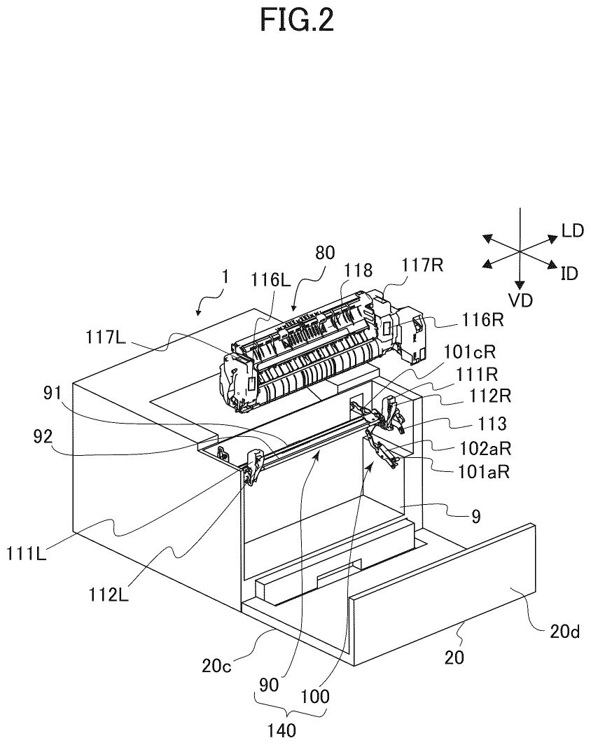

Next, the moving unit 140 will be described with reference to FIG. 2. FIG. 2 is a perspective view illustrating a state in which the fixing unit 80 has been detached from the moving unit 140.

The moving unit 140 is disposed between a right side plate and a left side plate constituting part of the main frame 10, and includes a support portion 90 and a lifting/lowering portion 100 as illustrated in FIG. 2. The lifting/lowering portion 100 includes an arm unit disposed on one side in a longitudinal direction LD of the fixing unit 80, and an arm unit disposed on the other side in the longitudinal direction LD of the fixing unit 80. The two arm units have substantially the same configuration, and therefore only the arm unit on the one side (right side) of the fixing unit 80 in the longitudinal direction LD will be described. To be noted, the longitudinal direction LD is a direction orthogonal to a vertical direction VD and parallel to the horizontal direction.

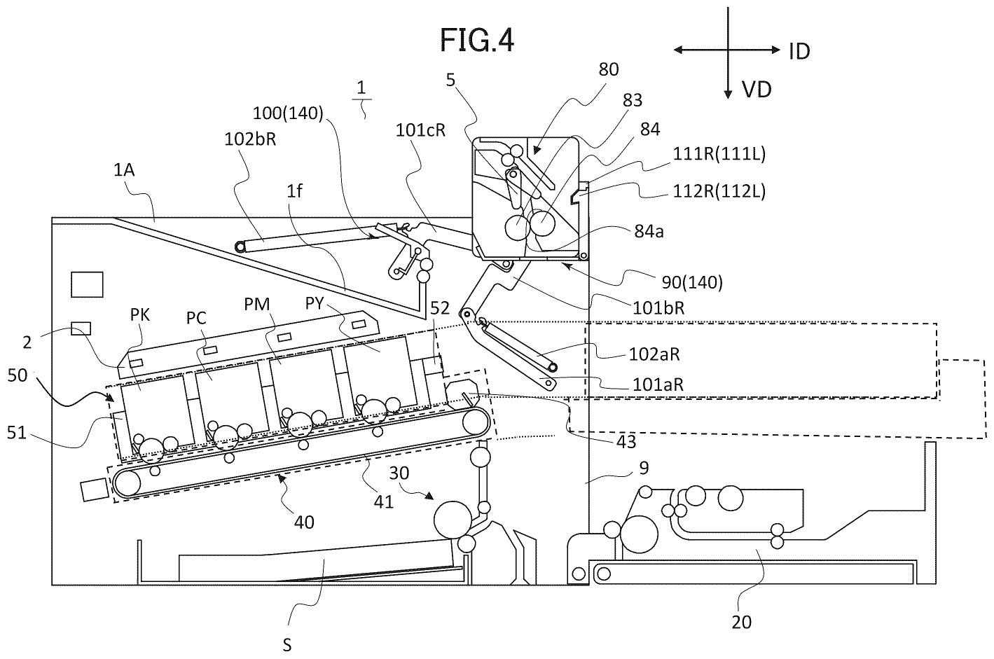

As illustrated in FIGS. 2 and 4, the arm unit includes arms 101aR, 101bR, and 101cR, and urging members 102aR and 102bR that urge the arms 101aR, 101bR, and 101cR. The arms 101aR, 101bR, and 101cR constitute a link mechanism. To be noted, although the urging members 102aR and 102bR are each constituted by a coil spring in the present embodiment, the configuration is not limited to this. For example, the urging members 102aR and 102bR may be each constituted by a different spring such as a plate spring, and the urging members 102aR and 102bR may be constituted by a plurality of kinds of springs.

The support portion 90 includes a metal frame 91 and a shaft member 92 that extend in the longitudinal direction LD. The metal frame 91 is formed in an approximate C shape in plan view, and is coupled to the shaft member 92 such that the support portion 90 has a rectangular shape as a whole. As a result of this, the stiffness of the support portion 90 can be improved. The support portion 90 is coupled to the lifting/lowering portion 100, and moves up and down together with the lifting/lowering portion 100. The support portion 90 supports the bottom surface of the fixing unit 80. In other words, the support portion 90 supports the fixing unit 80 from below such that the fixing unit 80 is attachable and detachable.

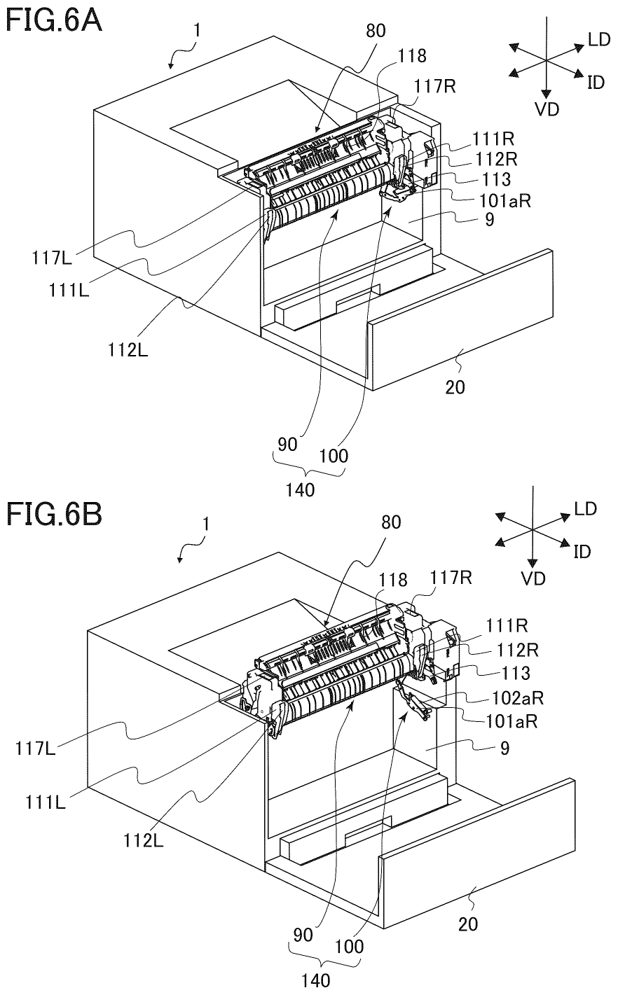

In a state in which the door 20 is positioned at the closed position, the fixing unit 80 is accommodated inside the image forming apparatus 1 as illustrated in FIG. 1, and is positioned at a first position where the fixing unit 80 can fix the toner image to the sheet S in the image forming operation. The moving unit 140 can move the fixing unit 80 to a second position illustrated in FIG. 6B in a state in which the fixing unit 80 is supported by the support portion 90. In the description below, the position of the moving unit 140 when the door 20 is positioned at the closed position will be referred to as an accommodated position, and the position of the moving unit 140 where the fixing unit 80 positioned at the second position can be supported will be referred to as a supporting position. That is, the moving unit 140 is configured to be capable of moving up from the accommodated position (position illustrated in FIG. 1) to the supporting position (position illustrated in FIG. 2) by the urging force of the urging members 102aR and 102bR and the like.

### Movement of Transfer Unit and Tray Unit

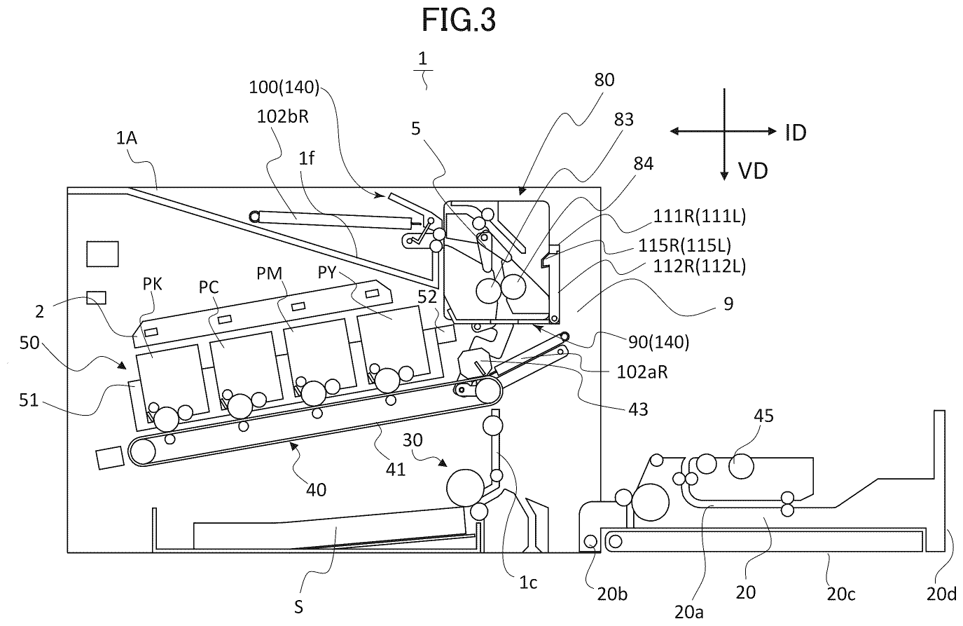

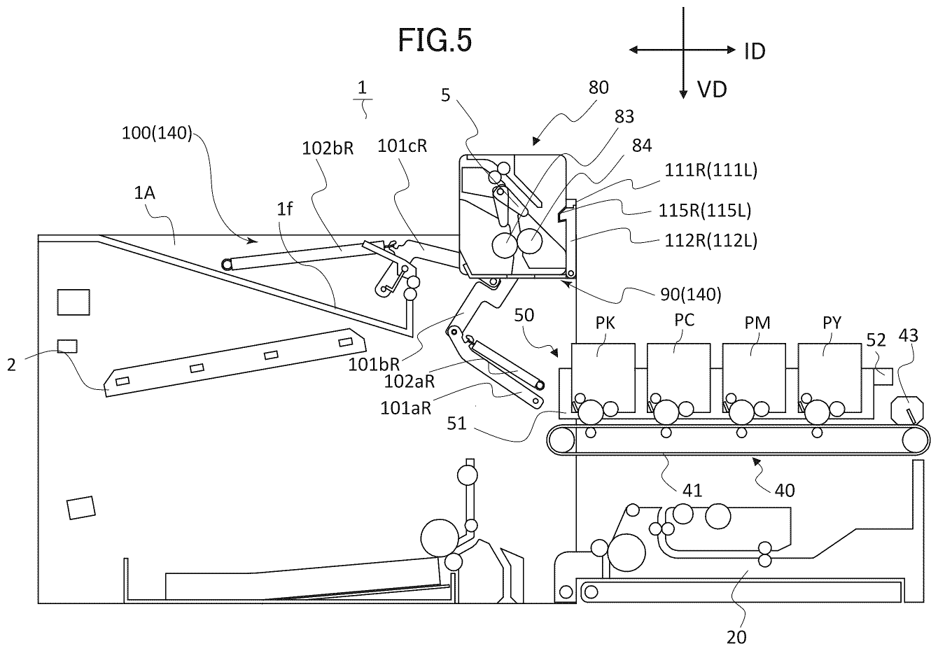

Next, the movement of the transfer unit 40 and the tray unit 50 will be described with reference to FIGS. 3 to 5. FIG. 3 is a section view of the image forming apparatus 1 in a state in which the door 20 is open. FIG. 4 is a section view of the image forming apparatus 1 in a state in which the fixing unit 80 has moved up to the second position. FIG. 5 is a section view of the image forming apparatus 1 in a state in which the transfer unit 40 and the tray unit 50 have been drawn out through the opening portion 9.

As illustrated in FIG. 3, when the door 20 is opened, the opening portion 9 of the apparatus body 1A is opened. When the door 20 is moved to the open position, the fixing unit 80 is exposed to the outside of the image forming apparatus 1 via the opening portion 9. Particularly, as illustrated in FIGS. 1 to 3, the door 20 includes a side surface 20c constituting one side surface of the image forming apparatus 1, and a top surface 20d constituting part of the top surface of the image forming apparatus 1, and is formed in an approximate L shape as a whole. That is, when the door 20 is moved to the open position, the space above the fixing unit 80 covered by the top surface 20d of the door 20 at the closed position is opened. Therefore, the fixing unit 80 can be moved up from the first position toward the second position. In other words, the movement of the fixing unit 80 from the first position to the second position is restricted in a state in which the door 20 is positioned at the closed position, and the movement of the fixing unit 80 from the first position to the second position is allowed in a state in which the door 20 is positioned at the open position. To be noted, in the present embodiment, the fixing unit 80 positioned at the first position does not overlap with the door 20 positioned at the closed position as viewed in the longitudinal direction LD, and the fixing unit 80 positioned at the second position at least partially overlaps with the door 20 positioned at the open position as viewed in the longitudinal direction LD.

In addition, as a result of the door 20 being opened from the closed position to the open position, the opening portion 9 is opened, and thus the conveyance path 1c and the duplex conveyance path 20a are exposed. As a result of this, the sheet S jammed in the conveyance path 1 or the duplex conveyance path 20a can be removed. In addition, the door 20 pivotably supports a secondary transfer frame 25 supporting the secondary transfer roller 45. By pivoting the secondary transfer frame 25 in a state in which the door 20 is positioned at the open position, the duplex conveyance path 20a can be opened widely.

Further, as illustrated in FIG. 4, when the fixing unit 80 moves to the second position as a result of the moving unit 140 moving up from the accommodated position to the supporting position, a space is generated below the fixing unit 80. As a result of this, the transfer unit 40 serving as an image forming portion for forming a toner image on a sheet and the tray unit 50 are attachable to and detachable from the apparatus body 1A via the opening portion 9 and the space below the fixing unit 80.

In a state in which the moving unit 140 has moved up to the supporting position, the transfer unit 40 and the tray unit 50 can be attached to and detached from the apparatus body 1A even when the fixing unit 80 is attached to the support portion 90. That is, in a state in which the fixing unit 80 is positioned at the second position, the transfer unit 40 and the tray unit 50 are attachable to and detachable from the apparatus body 1A via the opening portion 9. The transfer unit 40 and the tray unit 50 are drawn out from or attached to the apparatus body 1A in an intersecting direction ID intersecting with both the vertical direction VD and the longitudinal direction LD. The intersecting direction ID and the longitudinal direction LD are parallel to the horizontal plane.

As illustrated in FIG. 5, in a state in which the transfer unit 40 and the tray unit 50 have been drawn out to the outside of the apparatus body 1A, the process cartridges PY, PM, PC, and PK are attachable to and detachable from the tray 51. Therefore, the process cartridges PY PM, PC, and PK can be replaced. In addition, the transfer unit 40 can be also replaced.

As described above, the fixing unit 80, the transfer unit 40, and the tray unit 50 are each configured to be attachable to and detachable from the image forming apparatus 1 on the door 20 side. Therefore, when attaching or detaching the fixing unit 80, the transfer unit 40, and the tray unit 50, the image forming apparatus 1 can be accessed from one side, which improves the usability and reduces the installation space for installing the image forming apparatus 1. In addition, since the cassette 31 is also configured to be attachable to and detachable from the apparatus body 1A on the same side as the opening portion 9, the usability can be improved and the required space can be reduced.

Meanwhile, the fixing unit 80 positioned at the first position overlaps with a movement trajectory of attachment and detachment of the transfer unit 40 and the tray unit 50 to and from the apparatus body 1A. Therefore, the image forming apparatus 1 can be miniaturized. To be noted, in the present embodiment, the transfer unit 40 and the tray unit 50 are configured to be attachable to and detachable from the apparatus body 1A independently from each other, but may be configured to be integrally attachable to and detachable from the apparatus body 1A.

### Attachment/Detachment Operation of Fixing Unit

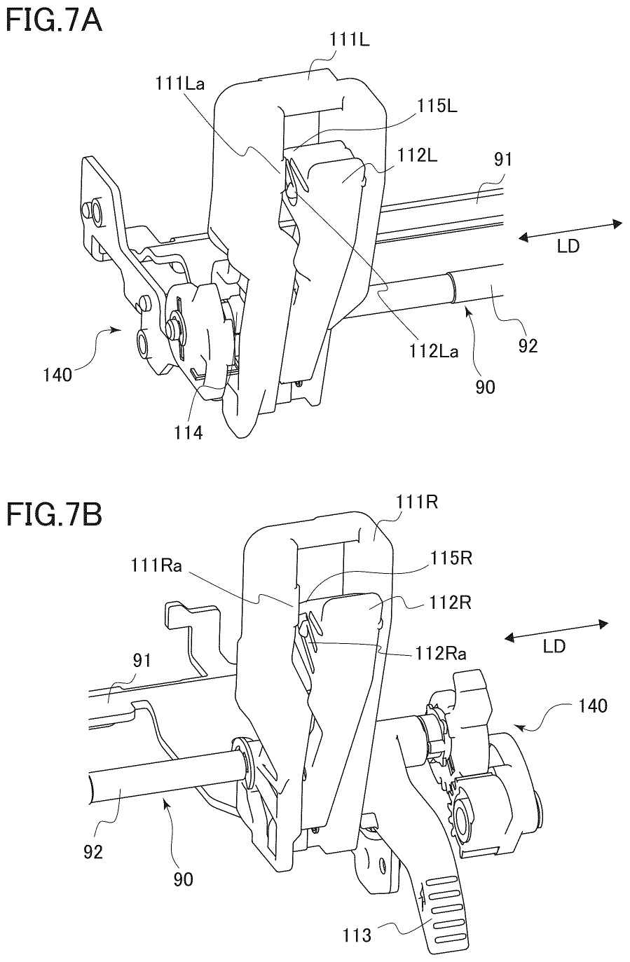

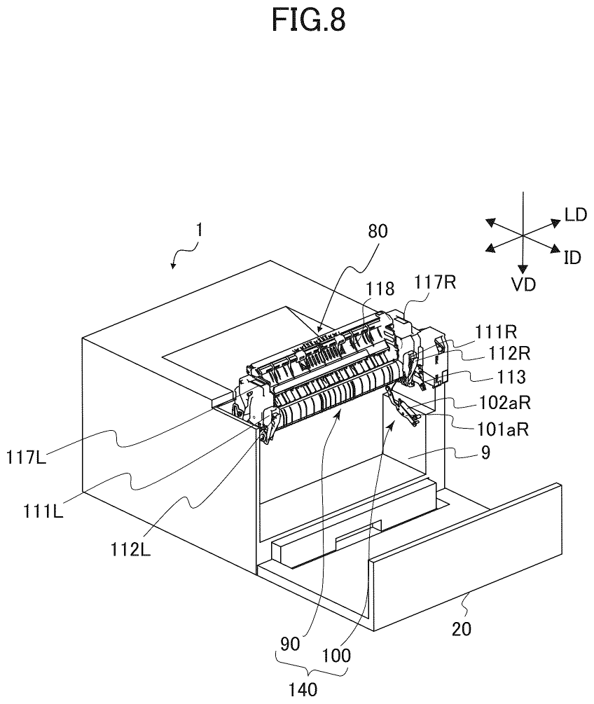

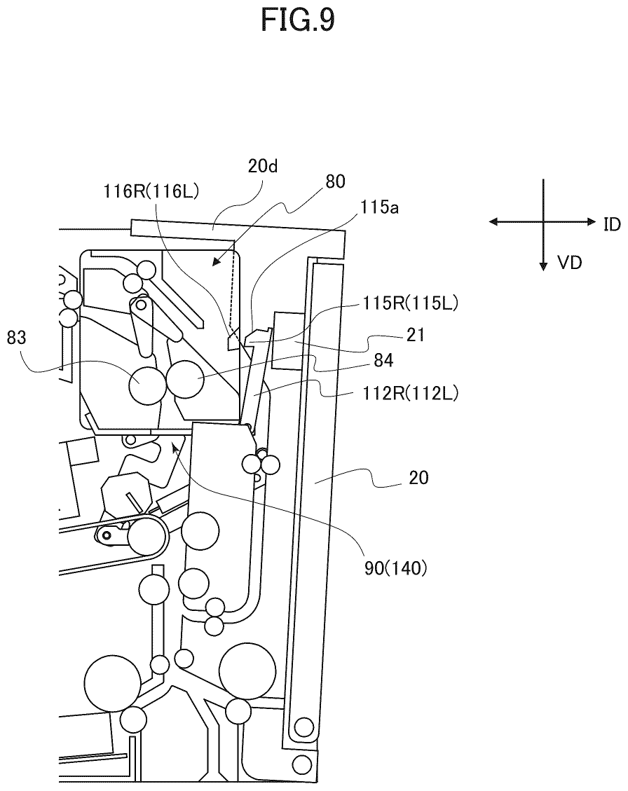

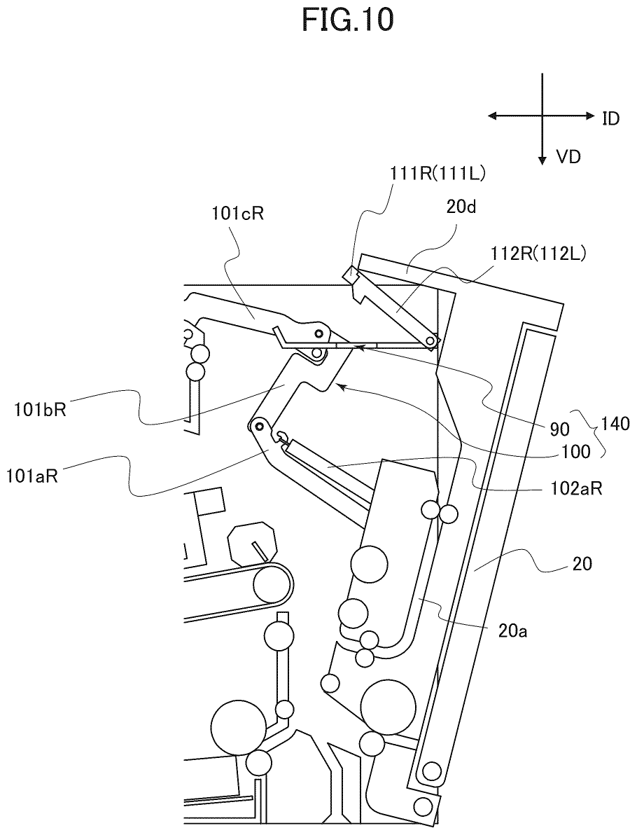

Next, the attachment/detachment operation of the fixing unit 80 will be described with reference to FIGS. 2 and 6A to 10. FIG. 6A is a section view of the image forming apparatus 1 in a state in which the door 20 is open. FIG. 6B is a perspective view of the fixing unit 80 positioned at the second position. FIG. 7A is an enlarged perspective view of a restricting member 111L and a locking member 112L that are provided on the left side, and FIG. 7B is an enlarged perspective view of a restricting member 111R, a locking member 112R, and a releasing lever 113 that are provided on the right side. FIG. 8 is a perspective view illustrating a state in which the locking members 112L and 112R have been moved to a detachment allowing position. FIG. 9 is a section view illustrating a state in which a pressing rib 21 of the door 20 presses the locking members 112L and 112R. FIG. 10 is a section view illustrating a state in which the top surface 20d of the door 20 presses the restricting members 111L and 111R.

First, a procedure of detaching the fixing unit 80 from the support portion 90 of the moving unit 140 will be described. As illustrated in FIG. 6A, the user first moves the door 20 from the closed position to the open position. Here, an unillustrated fixing lock member is provided on the fixing unit 80, and the fixing lock member engages with an unillustrated locked portion provided in the apparatus body 1A such that the fixing unit 80 is held at the first position. That is, in a state in which the fixing lock member of the fixing unit 80 is engaged with the locked portion of the apparatus body 1A, upward movement of the moving unit 140 from the accommodated position to the supporting position is restricted. For example, in the case of performing jam removal in the conveyance path 1 or the duplex conveyance path 20a, the user can perform the jam removal in the state of FIG. 6A.

As illustrated in FIGS. 6A, 6B, 7A, and 7B, the restricting member 111L and the locking member 112L are provided on one side (left side) of the moving unit 140 in the longitudinal direction LD. The restricting member 111R, the locking member 112R, and the releasing lever 113 are provided on the other side (right side) of the moving unit 140 in the longitudinal direction LD. The restricting members 111L and 111R, the locking members 112L and 112R, and the releasing lever 113 are supported to be pivotable with respect to the shaft member 92. That is, the restricting members 111L and 111R, the locking members 112L and 112R, and the releasing lever 113 are relatively pivotable with respect to each other about the shaft member 92 that is the same shaft.

The restricting members 111L and 111R each have a shape to cover corresponding one of the locking members 112L and 112R. Engagement claws 112La and 112Ra that are elastically deformed by a predetermined force are respectively provided on the side surfaces of the locking members 112L and 112R serving as detachment restricting portions. Protrusions 111La and 111Ra that the engagement claws 112La and 112Ra can climb over by a predetermined force are respectively provided on the restricting members 111L and 111R. In a state in which the engagement claws 112La and 112Ra are engaged with the protrusions 111La and 111Ra, the locking members 112L and 112R respectively integrally pivot with the restricting members 111L and 111R.

Meanwhile, by a pivoting operation of the locking members 112L and 112R by the user, the locking members 112L and 112R can relatively pivot with respect to the restricting members 111L and 111R while cancelling the engagement between the engagement claws 112La and 112Ra and the protrusions 111La and 111Ra. Claw portions 115L and 115R are respectively provided on distal end portions of the restricting members 111L and 111R as illustrated in FIGS. 7A, 7B, and 9. In addition, recess portions 116L and 116R that the claw portions 115L and 115R are capable of engaging with are provided on the fixing unit 80 as illustrated in FIG. 2. The claw portions 115L and 115R engage with the recess portions 116L and 116R, and thus upward movement of the fixing unit 80 is restricted. That is, in a state in which the claw portions 115L and 115R are engaged with the recess portions 116L and 116R, detachment of the fixing unit 80 supported by the support portion 90 from the support portion 90 is restricted.

The restricting members 111L and 111R are movable to a detachment restricting position where the claw portions 115L and 115R engage with the recess portions 116L and 116R, and a detachment allowing position where the claw portions 115L and 115R are separated from the recess portions 116L and 116R. That is, the restricting members 111L and 111R restrict detachment of the fixing unit 80 from the support portion 90 at the detachment restricting position, and allow the detachment of the fixing unit 80 from the support portion 90 at the detachment allowing position.

In addition, as illustrated in FIG. 7A, the restricting member 111L is held in an erecting posture by a restricting spring 114. For example, the restricting spring 114 serving as an urging member is constituted by a torsion coil spring including a coil portion is supported by the shaft member 92, one end engaged with the restricting member 111L, and the other end engaged with the metal frame 91.

The restricting member 111R is also similarly held in an erecting posture by an unillustrated spring. To be noted, the restricting members 111L and 111R are configured to be pivotable about the shaft member 92 independently from each other in the present embodiment, the configuration is not limited to this. For example, the restricting members 111L and 111R may be configured to integrally pivot with each other, and in this case, only one restricting spring is needed. A position where no external force is applied to the restricting members 111L and 111R and the restricting members 111L and 111R are held in an erecting posture by the restricting spring 114 will be referred to as a home position. In a state in which the restricting members 111L and 111R are positioned at the home position and the engagement claws 112La and 112Ra are engaged with the protrusions 111La and 111Ra, the locking members 112L and 112R are positioned at the detachment restricting position.

The restricting members 111L and 111R positioned at the home position oppose the fixing unit 80 placed on the support portion 90 in the intersecting direction ID, and restricts dropping of the fixing unit 80 from the support portion 90. More specifically, the restricting members 111L and 111R serving as restricting portions restrict dropping of the fixing unit 80 from the support portion 90 toward the door 20 positioned at the open position.

As illustrated in FIG. 4, when the moving unit 140 is positioned at the supporting position, the restricting members 111L and 111R protrude higher than an upper surface Ig of the apparatus body 1A. That is, at least a part of the restricting members 111L and 111R is positioned above the upper surface 1g of the apparatus body 1A when the moving unit 140 is positioned at the supporting position. In addition, at least part of the restricting members 111L and 111R are positioned above an upper end 84a of the pressurizing roller 84 when the moving unit 140 is positioned at the supporting position. As a result of configuring the restricting members 111L and 111R in this manner, dropping of the fixing unit 80 from the support portion 90 can be restricted even in the case where a strong force is applied to the fixing unit 80.

In addition, since the restricting members 111L and 111R protrude higher than the upper surface 1g of the apparatus body 1A, the user can intuitively recognize the position to attach the fixing unit 80 when attaching the fixing unit 80 to the support portion 90 as described later. As a result of this, the attachability and detachability of the fixing unit 80 and the usability can be improved.

As illustrated in FIG. 7B, the releasing lever 113 is configured to be capable of being pivoted by the user in the up-down direction, and the user can move the unillustrated fixing lock member of the fixing unit 80 described above by operating the releasing lever 113. The fixing lock member is supported by the frame member of the fixing unit 80 to be movable between a restricting position and an allowing position, and is urged toward the restricting position by an unillustrated urging member.

The fixing lock member can restrict the movement of the fixing unit 80 from the first position to the second position, that is, the upward movement of the moving unit 140 by engaging with the locked portion of the apparatus body 1A at the restricting position. In addition, at the allowing position, the engagement between the fixing lock member and the locked portion is cancelled, and thus the movement of the fixing unit 80 from the first position to the second position is allowed. As a result of the user operating the releasing lever 113, the fixing lock member moves from the restricting position to the allowing position.

As illustrated in FIGS. 6A and 6B, when the door 20 is opened from the closed position to the open position and the releasing lever 113 is operated by the user, the fixing lock member of the fixing unit 80 moves from the restricting position to the allowing position, and thus the upward movement of the moving unit 140 is started. As a result of this, the moving unit 140 moves up from the accommodated position to the supporting position, and the fixing unit 80 moves up from the first position to the second position.

Next, as illustrated in FIG. 8, the user pivots the locking members 112L and 112R from the detachment restricting position to the detachment allowing position. As a result of this, the claw portions 115L and 115R of the locking members 112L and 112R are separated from the recess portions 116L and 116R (see FIG. 2) of the fixing unit 80, and thus it becomes possible to detach the fixing unit 80 from the support portion 90.

In this state, the user can lift up gripping portions 117L and 117R provided on the upper surface of the fixing unit 80 and thus detach the fixing unit 80 from the support portion 90. The fixing unit 80 is merely placed on the metal frame 91 and the shaft member 92 of the support portion 90, and therefore the fixing unit 80 can be easily detached from the support portion 90 by just lifting up the fixing unit 80.

To be noted, in a state in which the moving unit 140 has moved up to the supporting position, the gripping portions 117L and 117R are positioned above the upper surface 1g of the apparatus body 1A. Therefore, the user can easily lift up the fixing unit 80, and thus the operability can be improved.

In a state in which the fixing unit 80 is detached from the support portion 90, as illustrated in FIG. 2, the support portion 90 can be visually recognized. In addition, the metal frame 91 and the shaft member 92 of the support portion 90 extend in the longitudinal direction LD for approximately the entire length of the fixing unit 80, and the user can intuitively recognize the position to place the fixing unit 80. Further, in a state in which the fixing unit 80 is detached from the support portion 90, the moving unit 140 is held at the supporting position, therefore the support portion 90 is positioned near the opening portion 9, and the visual recognizability of the support portion 90 can be improved.

For example, when a consumable portion of the fixing unit 80 has expired, the fixing unit 80 is replaced. When attaching a brand-new fixing unit 80 to the support portion 90, the user moves the fixing unit 80 toward the support portion 90 from above by hooking the fingers on the gripping portions 117L and 117R. At this time, if the locking members 112L and 112R are positioned at the detachment restricting portion, the lower surface of the fixing unit 80 comes into contact with the locking members 112L and 112R.

In the present embodiment, the locking members 112L and 112R each have a taper surface 115a as illustrated in FIG. 9, and the locking members 112L and 112R are moved to the detachment allowing position by the fixing unit 80 pressing the taper surfaces 115a. Therefore, the fixing unit 80 can be attached to the support portion 90 even in a state in which the locking members 112L and 112R are positioned at the detachment restricting position.

To be noted, in the present embodiment, the engagement claws 112La and 112Ra engage with the protrusions 111La and 111Ra, and thus the locking members 112L and 112R can remain at the detachment restricting position.

Then, the user pushes down the fixing unit 80 or the moving unit 140, and thus the fixing unit 80 is moved down until the movement of the fixing unit 80 is restricted by the locked portions. In a state in which the fixing lock member provided on the fixing unit 80 is engaged with the locked portion of the apparatus body 1A, the fixing unit 80 is positioned at the first position. Therefore, the user can intuitively determine to which position the fixing unit 80 should be pushed down. Then, the user closes the door 20, and thus the replacement of the fixing unit 80 is completed.

To be noted, as illustrated in FIG. 9, the pressing rib 21 is provided on a surface of the door 20 opposing the fixing unit 80. The pressing rib 21 is provided at each position corresponding to the locking member 112L or 112R provided on the right side and the left side. For example, a case where the engagement between the engagement claws 112La and 112Ra and the protrusions 111La and 111Ra is cancelled and the user closes the door 20 in a state in which the locking members 112L and 112R are still positioned at the detachment restricting position will be considered.

At this time, the pressing ribs 21 provided on the left side and the right side press the locking members 112L and 112R immediately before the door 20 reaches the closed position. Then, when the door 20 reaches the closed position, the locking members 112L and 112R pivot to the detachment restricting position by being pressed by the pressing ribs 21, and thus the fixing unit 80 is locked by the locking members 112L and 112R. Therefore, the fixing unit 80 is reliably locked to the support portion 90, and the fixing unit 80 can be reliably held at the first position in a state in which the door 20 is closed.

In addition, as illustrated in FIG. 10, a case where the door 20 is closed from the open position to the closed position in a state in which the moving unit 140 is positioned at the supporting position and the fixing unit 80 is detached from the support portion 90 of the moving unit 140 will be considered. The restricting members 111L and 111R are supported to be pivotable about the shaft member 92, and are therefore pressed toward the discharge tray if by the door 20 while the door 20 moves from the open position to the closed position. As a result of this, the restricting members 111L and 111R pivot about the shaft member 92. As a result of this, breakage of the restricting members 111L and 111R can be suppressed. In addition, the door 20 can move to the closed position even in a state in which the fixing unit 80 is not placed on the support portion 90 of the moving unit 140.

### Jam Removal in Fixing Unit

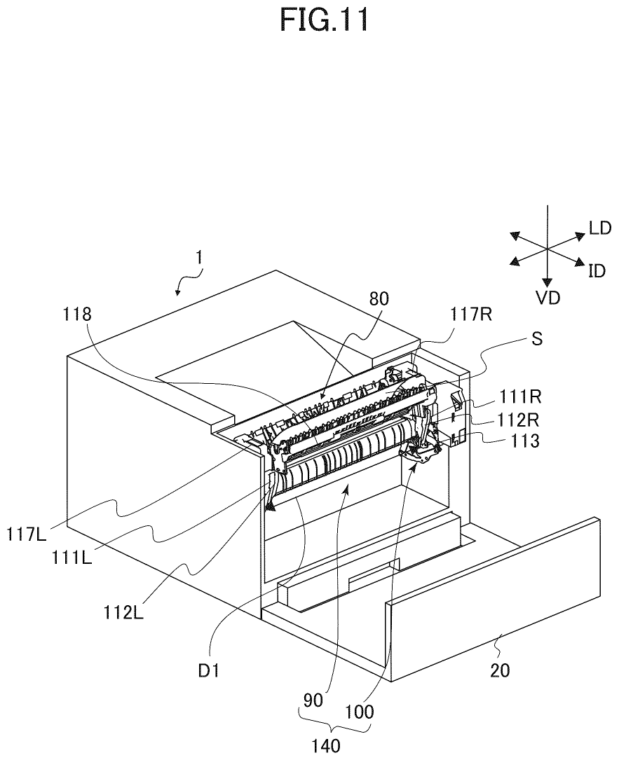

Next, a method for removing the sheet S jammed in the fixing unit 80 will be described with reference to FIG. 11. FIG. 11 is a perspective view illustrating how a jam removal of the sheet Snipped in the fixing unit 80 is performed.

As illustrated in FIG. 11, in the case of removing the sheet S nipped in the fixing nip of the fixing unit 80, the fixing unit 80 is moved up to the second position in the same manner as the detachment of the fixing unit 80 described above. Then, the sheet S nipped in the fixing nip can be pulled out downward, or upward to the front side by choice. In the case of pulling out the sheet S downward, the user pulls out the sheet S downward in a state in which the fixing unit 80 is still placed on the support portion 90.

In contrast, in the case of pulling out the sheet S upward to the front side, the user first opens a cover 118 that is openable and closable and provided on the fixing unit 80. As a result of this, the user can access the vicinity of the fixing nip of the fixing unit 80. When the user pulls the sheet S upward to the front side, force in a direction upward in the vertical direction VD and to the front side in the intersecting direction ID acts on the fixing unit 80 via the sheet S.

However, the fixing unit 80 is positioned in the intersecting direction ID by the restricting members 111L and 111R, and is positioned in the vertical direction VD by the support portion 90 and the claw portions 115L and 115R of the locking members 112L and 112R. As a result of this, dropping of the fixing unit 80 from the support portion 90 toward the door 20 positioned at the open position is restricted by the restricting members 111L and 111R and the locking members 112L and 112R even in the case of performing jam removal of the sheet S nipped in the fixing unit 80.

To be noted, as described with reference to FIG. 9, the fixing unit 80 is locked by the restricting members 111L and 111R by closing the door 20. Therefore, a situation in which the restricting members 111L and 111R are separated from the fixing unit 80 during the jam removal of the sheet S nipped in the fixing unit 80 can be suppressed. In addition, the jam removal described above can be performed not only in the case where the fixing unit 80 is positioned at the second position but also in the case where the fixing unit 80 is positioned at the first position. Also in this case, dropping of the fixing unit 80 from the support portion 90 toward the door 20 positioned at the open position is restricted by the restricting members 111L and 111R and the locking members 112L and 112R.

In addition, in the present embodiment, the fixing unit 80 is moved up by the moving unit 140, and is thus exposed to the upper side through the opening portion 9. Since the upward movement of the fixing unit 80 is performed toward the upper side in approximately the vertical direction, the movement distance thereof is shorter than in the case of, for example, moving the fixing unit 80 upward by pivoting. Therefore, time required for replacement of the fixing unit 80 or jam removal can be reduced, and thus the attachability an detachability of the fixing unit 80 and the jam removability can be improved.

In addition, the restricting members 111L and 111R are disposed at a position more outward than the cover 118 of the fixing unit 80 in the longitudinal direction LD. Therefore, the restricting members 111L and 111R can be designed without considering the limitation of the conveyance path of the sheet S, and thus the design flexibility can be improved. For example, since the restricting members 111L and 111R can be made closer to the fixing unit 80, and thus displacement of the fixing unit 80 can be restricted. In addition, the opening angle of the cover 118 can be increased in a state in which the fixing unit 80 is placed on the support portion 90, and thus the operability of removal of the sheet S jammed in the fixing nip can be improved.

Further, the restricting member 111R serving as a second restricting member is disposed at a position different from that of the restricting member 111L serving as a first restricting member in the longitudinal direction LD. More specifically, the distance D1 between the restricting members 111L and 111R is larger than the width of the sheet of the maximum size that can be used in the image forming apparatus 1. In other words, in the longitudinal direction LD, the restricting members 111L and 111R are disposed outside a region that the sheet can pass through. Therefore, the restricting members 111L and 111R do not interfere with the sheet S pulled by the user, and thus the jam removability can be improved.

As described above, dropping of the fixing unit 80 positioned at the second position from the support portion 90 can be suppressed by the restricting members 111L and 111R and the locking members 112L and 112R. As a result of this, breakage of the fixing unit 80 can be reduced. In addition, since dropping of the fixing unit 80 from the support portion 90 can be suppressed even when the sheet S jammed in a state of being nipped in the fixing unit 80 is pulled, and thus the jam removability can be improved.

### Other Embodiments

To be noted, although the moving unit 140 is provided with the pair of restricting members 111L and 111R in the embodiment described above, the configuration is not limited to this. For example, the moving unit 140 may be provided with one restricting member or three or more restricting members.

In addition, although the moving unit 140 is provided with the pair of locking members 112L and 112R in the embodiment described above, the configuration is not limited to this. For example, the moving unit 140 may be provided with one locking member or three or more locking members.

In addition, although the dropping of the fixing unit 80 from the support portion 90 is suppressed by the restricting members 111L and 111R and the locking members 112L and 112R in the embodiment described above, the configuration is not limited to this. For example, the locking members 112L and 112R may be omitted, and the dropping of the fixing unit 80 from the support portion 90 may be suppressed by the restricting members 111L and 111R. Alternatively, the restricting members 111L and 111R may be omitted, and the dropping of the fixing unit 80 from the support portion 90 may be suppressed by the locking members 112L and 112R.

In addition, although the restricting members 111L and 111R and the locking members 112L and 112R are pivotably supported by the same shaft member 92 in the embodiment described above, the configuration is not limited to this. For example, the locking members 112L and 112R may be respectively pivotably supported by the restricting members 111L and 111R.

In addition, although the second position of the fixing unit 80 is above the first position in the embodiment described above, the configuration is not limited to this. For example, the fixing unit 80 may be moved in the horizontal direction from the first position to the second position, or may be moved diagonally downward from the first position to the second position.

In addition, although the lifting/lowering portion 100 includes a link mechanism constituted by a plurality of arms in the embodiment described above, the configuration is not limited to this. For example, the lifting/lowering portion 100 may include a rack portion, and the support portion 90 or 190 may be configured to be lifted and lowered via engagement between the rack portion and a pinion gear provided on the support portion 90 or 190. In addition, the support portion 90 or 190 may be provided with a pinion gear, and the lifting/lowering portion 100 may be provided with a rack member. As described above, the configuration of the lifting/lowering portion 100 is not limited.

In addition, although the fixing unit 80 includes the heating roller 83 and the pressurizing roller 84 in the embodiment described above, the configuration is not limited to this. For example, a heating unit including a heater such as a ceramic heater and a fixing film heated by the heater may be used instead of the heating roller 83. In addition, a fixing belt including a heat generating layer that generates heat by induction heating may be used instead of the heating roller 83.

In addition, although the photosensitive drum 61, the charging roller 62, and the developing roller 71 are provided in each of the process cartridges (PY to PK) in the embodiment described above, the configuration is not limited to this. That is, the photosensitive drum 61, the charging roller 62, and the developing roller 71 may be provided in the process cartridge or the tray 51.

In addition, although the door 20 is provided to be pivotable about the pivot shaft 20b in the embodiment described above, the configuration is not limited to this. For example, a cover that is slidable or detachable with respect to the apparatus body 1A may be provided instead of the door 20.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-039389, filed Mar. 13, 2024, which is hereby incorporated by reference herein in its entirety.

What is claimed is:

1. An image forming apparatus configured to form a toner image on a sheet, the image forming apparatus comprising:
an apparatus body provided with an opening portion;
an opening/closing member supported to be openable and closable with respect to the apparatus body between a closed position where the opening/closing member covers the opening portion and an open position where the opening/closing member opens the opening portion;
a fixing unit supported to be attachable to and detachable from the apparatus body via the opening portion and configured to fix the toner image to the sheet by applying heat and pressure to the sheet; and
a moving unit provided in the apparatus body and configured to move the fixing unit from a first position toward a second position different from the first position,
wherein a movement of the fixing unit from the first position to the second position is restricted in a state in which the opening/closing member is positioned at the closed position and is allowed in a state in which the opening/closing member is positioned at the open position, and
wherein the moving unit includes:
a support portion configured to support the fixing unit positioned at the second position; and
a restricting portion configured to restrict dropping of the fixing unit supported by the support portion from the support portion.

2. The image forming apparatus according to claim 1, wherein the support portion extends in a longitudinal direction of the fixing unit and supports the fixing unit from below.

3. The image forming apparatus according to claim 1, wherein the fixing unit positioned at the first position does not overlap with the opening/closing member positioned at the closed position as viewed in a longitudinal direction of the fixing unit, and
wherein at least a part of the second position of the fixing unit overlaps with the opening/closing member positioned at the closed position when viewed in the longitudinal direction of the fixing unit.

4. The image forming apparatus according to claim 1, wherein the second position is above the first position.

5. The image forming apparatus according to claim 1, wherein the restricting portion restricts the dropping of the fixing unit from the support portion toward the opening/closing member positioned at the open position.

6. The image forming apparatus according to claim 1, wherein the restricting portion includes:
a first restricting member opposing the fixing unit in an intersecting direction intersecting with both a longitudinal direction of the fixing unit and a vertical direction; and
a second restricting member disposed at a different position from the first restricting member in the longitudinal direction, the second restricting member opposing the fixing unit in the intersecting direction.

7. The image forming apparatus according to claim 6, wherein a distance between the first restricting member and the second restricting member in the longitudinal direction is larger than a width of the sheet of a maximum size usable in the image forming apparatus.

8. The image forming apparatus according to claim 1, wherein the fixing unit includes a cover that is openable and closable, and
wherein the restricting portion is disposed at a position more outward than the cover in a longitudinal direction of the fixing unit.

9. The image forming apparatus according to claim 1, wherein the restricting portion is pivotably supported by the support portion.

10. The image forming apparatus according to claim 9, wherein the moving unit is movable between an accommodated position where the moving unit is positioned in a case where the opening/closing member is positioned at the closed position, and a supporting position where the moving unit is capable of supporting the fixing unit positioned at the second position, and
wherein in a case where the opening/closing member is moved from the open position to the closed position in a state in which the moving unit is positioned at the supporting position and the fixing unit is detached from the support portion of the moving unit, the restricting portion pivots by being pressed by the opening/closing member.

11. The image forming apparatus according to claim 9, further comprising an urging member configured to urge the restricting portion toward a position which opposes the fixing unit positioned at the second position and where the restricting portion restricts the dropping of the fixing unit supported by the support portion from the support portion.

12. The image forming apparatus according to claim 1, wherein the moving unit is movable between an accommodated position where the moving unit is positioned in a case where the opening/closing member is positioned at the closed position, and a supporting position where the moving unit is capable of supporting the fixing unit positioned at the second position, and
wherein at least a part of the restricting portion is positioned above an upper surface of the apparatus body when the moving unit is positioned at the supporting position.

13. The image forming apparatus according to claim 1, wherein the moving unit is movable between an accommodated position where the moving unit is positioned in a case where the opening/closing member is positioned at the closed position, and a supporting position where the moving unit is capable of supporting the fixing unit positioned at the second position,
wherein the fixing unit includes:
a heating unit configured to heat the toner image on the sheet; and
a pressurizing roller configured to nip the sheet together with the heating unit, and
wherein at least a part of the restricting portion is positioned above an upper end of the pressurizing roller in a case where the moving unit is positioned at the supporting position.

14. The image forming apparatus according to claim 1, wherein the moving unit includes a detachment restricting portion configured to restrict detachment of the fixing unit from the support portion by engaging with the fixing unit supported by the support portion.

15. The image forming apparatus according to claim 14, wherein the detachment restricting portion is movable between a detachment restricting position where the detachment restricting portion restricts the detachment of the fixing unit from the support portion by engaging with the fixing unit, and a detachment allowing position where the detachment restricting portion is separated from the fixing unit to allow the detachment of the fixing unit from the support portion.

16. The image forming apparatus according to claim 15, wherein the detachment restricting portion moves to the detachment restricting position by being pressed by the opening/closing member in a case where the opening/closing member moves from the open position toward the closed position.

17. The image forming apparatus according to claim 14, wherein the detachment restricting portion is pivotably supported by the support portion.

18. The image forming apparatus according to claim 14, wherein the restricting portion and the detachment restricting portion are supported to be pivotable about a same shaft member.

19. The image forming apparatus according to claim 1, further comprising an image forming portion configured to form the toner image on the sheet,
wherein the image forming portion is configured to be attachable to and detachable from the apparatus body via the opening portion in a state in which the fixing unit has been moved to the second position by the moving unit.
